(19) United States
(12) Patent Application Publication
(10) Pub. No.: US 2026/0121316 A1
(43) Pub. Date: Apr. 30, 2026

(54) CONNECTOR ASSEMBLY

(71) Applicant: Japan Aviation Electronics Industry, Ltd., Tokyo (JP)

(72) Inventor: Daisuke Machihara, Tokyo (JP)

(73) Assignee: Japan Aviation Electronics Industry, Ltd., Tokyo (JP)

(21) Appl. No.: 19/332,518

(22) Filed: Sep. 18, 2025

(30) Foreign Application Priority Data
Oct. 29, 2024 (JP) 2024-189643

(51) Int. Cl. H01R 12/71

(52) U.S. Cl. CPC H01R 12/716

(57) ABSTRACT

A connector assembly includes a receptacle connector and a plug connector. The plug connector is vertically inserted into the receptacle connector and then horizontally moved relative to the receptacle connector, whereby the receptacle connector and the plug connector are electrically connected. Two receptacle-side auxiliary fittings include at least three receptacle-side interference portions that physically interfere with the plug connector when a misalignment exists between the plug connector and the receptacle connector in the width direction during vertical insertion.

### INCORPORATION BY REFERENCE

This application is based upon and claims the benefit of priority from Japanese patent application No. 2024-189643, filed on Oct. 29, 2024, the disclosure of which is incorporated herein in its entirety by reference.

### BACKGROUND

The present disclosure relates to a connector assembly.

Patent Literature 1 discloses, as illustrated in FIG. 18 of the present application, a connector assembly 102 in which a connector 100 and a connector 101 are mated with each other by first positioning the connector 100 with respect to the connector 101 in the vertical direction and then moving the connector 100 relative to the connector 101 in the horizontal direction.
Patent Literature 1: Japanese Patent Publication No. 5530278

### SUMMARY

In the configuration of Patent Literature 1, there is a possibility that contacts may be damaged when mating the connector 100 with the connector 101.

It is an object of the present disclosure to provide a connector assembly in which the contacts are less likely to be damaged during mating.

A connector assembly comprises a receptacle connector and a plug connector. The plug connector is vertically inserted into the receptacle connector, and is then moved horizontally relative to the receptacle connector, whereby the receptacle connector and the plug connector are electrically connected. The receptacle connector includes: a plurality of first receptacle-side contacts; a plurality of second receptacle-side contacts; a receptacle-side housing that retains the plurality of first and second receptacle-side contacts; and at least one receptacle-side auxiliary fitting. The receptacle-side housing includes: a first receptacle-side contact beam that retains the plurality of first receptacle-side contacts; a second receptacle-side contact beam that retains the plurality of second receptacle-side contacts; and two receptacle-side connecting beams that connect the first and second receptacle-side contact beams. The plug connector includes: a plurality of first plug-side contacts; a plurality of second plug-side contacts; a plug-side housing that retains the plurality of first and second plug-side contacts; and at least one plug-side auxiliary fitting. The plug-side housing includes: a first plug-side contact beam that retains the plurality of first plug-side contacts; a second plug-side contact beam that retains the plurality of second plug-side contacts; and two plug-side connecting beams that connect the first and second plug-side contact beams. The plug connector is vertically inserted into the receptacle connector such that the plug connector is accommodated between the two receptacle-side connecting beams, and is then moved horizontally relative to the receptacle connector, so that the plurality of first receptacle-side contacts respectively contact the plurality of first plug-side contacts, and the plurality of second receptacle-side contacts respectively contact the plurality of second plug-side contacts. The at least one receptacle-side auxiliary fitting includes at least three receptacle-side interference portions that physically interfere with the plug connector when a misalignment exists between the plug connector and the receptacle connector in a facing direction in which the first and second receptacle-side contact beams face each other during the vertical insertion.

According to the present disclosure, it is possible to provide a connector assembly in which contacts are less likely to be damaged during mating.

The above and other objects, features and advantages of the present disclosure will become more fully understood from the detailed description given hereinbelow and the accompanying drawings.

### BRIEF DESCRIPTION OF DRAWINGS

FIG. 1 is a perspective view showing a connector assembly before mating (First embodiment);

FIG. 2 is an exploded perspective view of the connector assembly (First embodiment);

FIG. 3 is a perspective view of a receptacle connector (First embodiment);

FIG. 4 is a perspective view showing part of the configuration of the receptacle connector (First embodiment);

FIG. 5 is a perspective view of a plug connector (First embodiment);

FIG. 6 is a perspective view showing part of the configuration of the plug connector (First embodiment);

FIG. 7 is a perspective view showing a state in which vertical insertion is completed (First embodiment);

FIG. 8 is a perspective view showing the positional relationship between a receptacle-side auxiliary fitting and a plug-side auxiliary fitting after vertical insertion (First embodiment);

FIG. 9 is a cross-sectional view showing a state in which vertical insertion is completed (First embodiment);

FIG. 10 is a perspective view showing a state in which horizontal movement is completed (First embodiment);

FIG. 11 is a perspective view showing the positional relationship between the receptacle-side auxiliary fitting and the plug-side auxiliary fitting after horizontal movement (First embodiment);

FIG. 12 is a perspective view showing a connector assembly before mating (Second embodiment);

FIG. 13 is an exploded perspective view of the connector assembly (Second embodiment);

FIG. 14 is a perspective view of a receptacle-side auxiliary fitting (Second embodiment);

FIG. 15 is a perspective view of a plug-side auxiliary fitting (Second embodiment);

FIG. 16 is a perspective view showing the positional relationship between the receptacle-side auxiliary fitting and the plug-side auxiliary fitting after vertical insertion (Second embodiment);

FIG. 17 is a perspective view showing the positional relationship between the receptacle-side auxiliary fitting and the plug-side auxiliary fitting after horizontal movement (Second embodiment); and

FIG. 18 is a view showing a simplified version of FIG. 1 of Patent Literature 1.

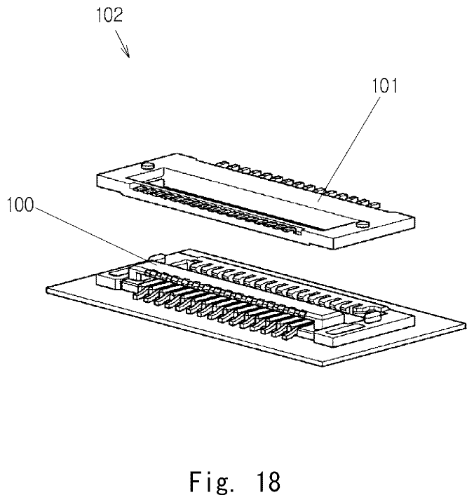

### DESCRIPTION OF EMBODIMENTS

Hereinafter, the present invention will be described through embodiments. However, the invention according to the claims is not limited to the embodiments described below. In addition, not all of the configurations described in the embodiments are necessarily essential as means for solving the problems. For clarity of explanation, the following description and drawings are partially omitted or simplified as appropriate. In the drawings, the same reference numerals are given to the same elements, and redundant explanation is omitted as needed.

In the following embodiments, for convenience of explanation, the description may be divided into a plurality of sections or embodiments when necessary. Unless explicitly stated otherwise, these are not independent of each other, but may be related as modifications, applications, detailed explanations, or supplementary explanations of one another. Further, in the following embodiments, when referring to numerical values such as the number, amount, quantity, or range of components, unless explicitly specified or clearly limited to a specific number in principle, such numbers are not limited to the specified values, and may include values greater or less than the stated ones.

Furthermore, in the following embodiments, unless explicitly stated or clearly considered essential in principle, each component (including operational steps and the like) is not necessarily essential.

Likewise, when referring to the shape, positional relationship, or the like of components, unless explicitly stated or clearly considered otherwise in principle, such descriptions shall be construed to include substantially similar or approximate configurations. The same applies to numerical references such as the number, value, quantity, or range.

### First Embodiment

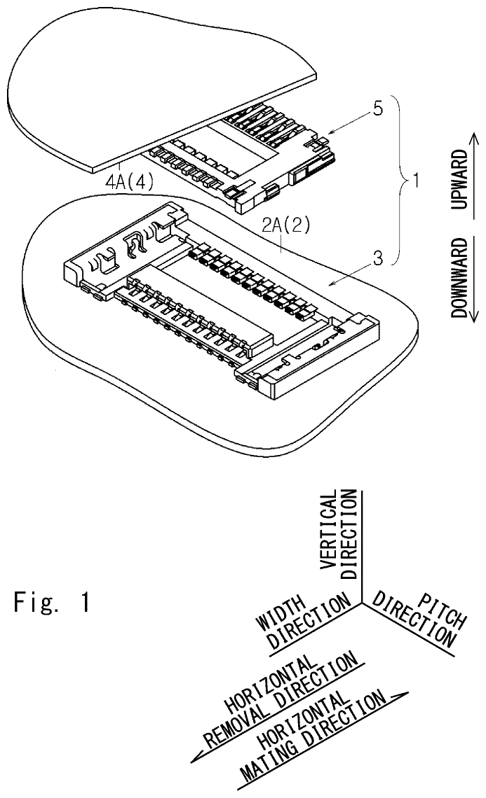

The first embodiment of the present disclosure will be described with reference to FIGS. 1 through 11. FIG. 1 is a perspective view showing a connector assembly 1 before mating.

As shown in FIG. 1, a connector assembly 1 includes a receptacle connector 3 mounted on a connector mounting surface 2A of a receptacle-side board 2 and a plug connector 5 mounted on a connector mounting surface 4A of a plug-side board 4. The connector assembly 1 mechanically and electrically connects the receptacle-side board 2 and the plug-side board 4. Specifically, the plug connector 5 is vertically inserted into the receptacle connector 3, and then horizontally moved relative to the receptacle connector 3, whereby the plug connector 5 mates with the receptacle connector 3. As a result of the mating, the receptacle-side board 2 and the plug-side board 4 are mechanically and electrically connected.

The receptacle-side board 2 is typically a rigid board, but may be a flexible board. The plug-side board 4 is typically a flexible board, but may also be a rigid board.

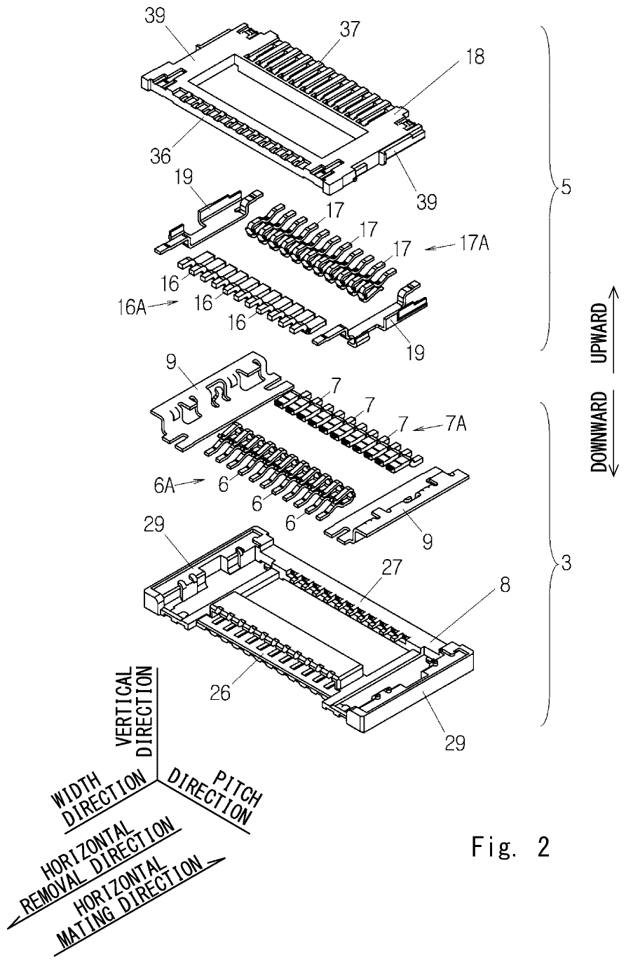

FIG. 2 is an exploded perspective view of the connector assembly 1.

As shown in FIG. 2, the receptacle connector 3 includes a plurality of receptacle-side female contacts 6, a plurality of receptacle-side male contacts 7, a receptacle-side housing 8, and two receptacle-side auxiliary fittings 9.

The plurality of receptacle-side female contacts 6 are arranged in a row at a predetermined pitch, thereby forming a receptacle-side female contact row 6A. Similarly, the plurality of receptacle-side male contacts 7 are arranged in a row at a predetermined pitch, thereby forming a receptacle-side male contact row 7A.

Here, three directions are defined: the pitch direction, the width direction, and the vertical direction. These directions are orthogonal to one another. The pitch and width directions are parallel to the connector mounting surface 2A of the receptacle-side board 2. The vertical direction is orthogonal to the connector mounting surface 2A.

The pitch direction is the longitudinal direction of the receptacle-side female contact row 6A. The pitch direction includes an inward in the pitch direction and an outward in the pitch direction. The inward in the pitch direction is toward the center of the connector assembly 1 in the pitch direction, while the outward in the pitch direction is away from the center in the pitch direction.

The width direction is the direction in which the receptacle-side female contact row 6A and the receptacle-side male contact row 7A face each other. The width direction is one example of a facing direction. The width direction includes an inward in the width direction and an outward in the width direction. The inward in the width direction is toward the center of the connector assembly 1 in the width direction, while the outward in the width direction is away from the center in the width direction.

The width direction also includes a horizontal mating direction and a horizontal removal direction. The horizontal mating direction is from the receptacle-side female contact row 6A toward the receptacle-side male contact row 7A. The horizontal removal direction is the opposite. Accordingly, in the horizontal mating direction, the receptacle-side female contact row 6A and the receptacle-side male contact row 7A are arranged in this order.

The vertical direction includes an upward direction and a downward direction. In the mated state of the connector assembly 1, the upward direction is from the receptacle-side board 2 toward the plug-side board 4, and the downward direction is the opposite.

The receptacle-side female contact row 6A and the receptacle-side male contact row 7A extend in the pitch direction and are spaced apart in the width direction.

The receptacle-side housing 8 includes: a receptacle-side female contact beam 26 that retains the receptacle-side female contact row 6A; a receptacle-side male contact beam 27 that retains the receptacle-side male contact row 7A; and two receptacle-side connecting beams 29 that connect the receptacle-side female contact beam 26 and the receptacle-side male contact beam 27. The two receptacle-side auxiliary fittings 9 are respectively retained by the two receptacle-side connecting beams 29.

The receptacle-side female contact beam 26 and the receptacle-side male contact beam 27 extend in the pitch direction and are spaced apart in the width direction. The two receptacle-side connecting beams 29 extend in the width direction and are spaced apart in the pitch direction.

Similarly, the plug connector 5 includes: a plurality of plug-side male contacts 16, a plurality of plug-side female contacts 17, a plug-side housing 18, and two plug-side auxiliary fittings 19.

The plurality of plug-side male contacts 16 are arranged in a row at a predetermined pitch, thereby forming a plug-side male contact row 16A. Likewise, the plurality of plug-side female contacts 17 are arranged in a row at a predetermined pitch, thereby forming a plug-side female contact row 17A.

The plug-side male contact row 16A and the plug-side female contact row 17A extend in the pitch direction and are spaced apart in the width direction. In the horizontal mating direction, the plug-side male contact row 16A and the plug-side female contact row 17A are arranged in this order.

The plug-side housing 18 includes: a plug-side male contact beam 36 that retains the plug-side male contact row 16A; a plug-side female contact beam 37 that retains the plug-side female contact row 17A; and two plug-side connecting beams 39 that connect the plug-side male contact beam 36 and the plug-side female contact beam 37. The two plug-side auxiliary fittings 19 are respectively retained by the two plug-side connecting beams 39.

The plug-side male contact beam 36 and the plug-side female contact beam 37 extend in the pitch direction and are spaced apart in the width direction. The two plug-side connecting beams 39 extend in the width direction and are spaced apart in the pitch direction.

### (Receptacle Connector 3)

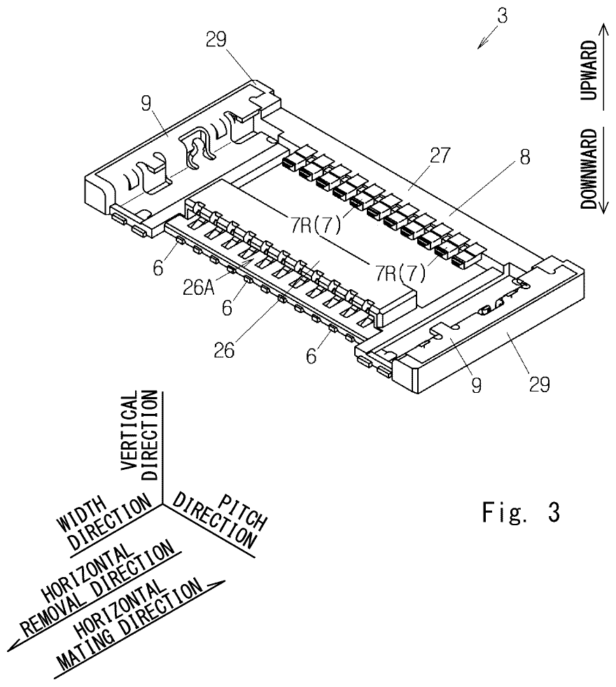

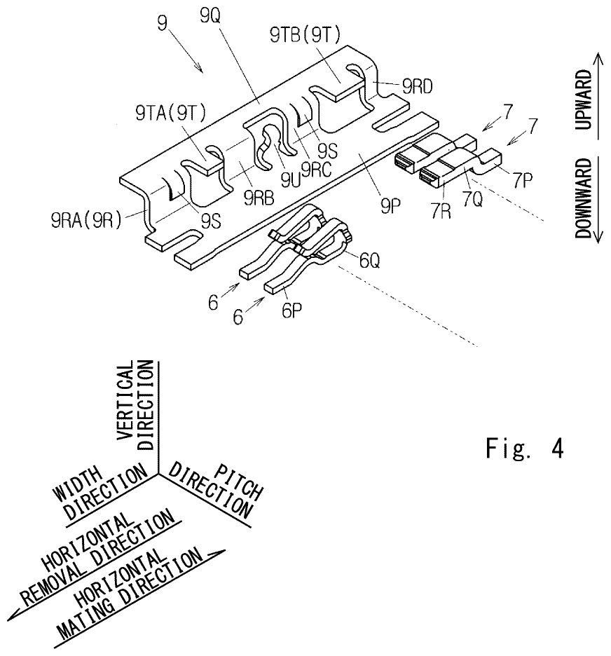

Next, the receptacle connector 3 will be described in more detail with reference to FIGS. 3 and 4. FIG. 3 is a perspective view of the receptacle connector 3. FIG. 4 is a perspective view showing only a part of the configuration of the receptacle connector 3.

The plurality of receptacle-side female contacts 6 are press-fitted and retained in respective slits formed in the receptacle-side female contact beam 26. As shown in FIG. 4, each receptacle-side female contact 6 includes a soldering portion 6P that is soldered to the connector mounting surface 2A of the receptacle-side board 2, and a U-shaped contact portion 6Q that opens in the horizontal removal direction. As shown in FIG. 3, an insertion opening 26A that opens in the horizontal removal direction is formed in the receptacle-side female contact beam 26.

The plurality of receptacle-side male contacts 7 are retained in the receptacle-side male contact beam 27 by insert molding. As shown in FIG. 4, each receptacle-side male contact 7 includes a soldering portion 7P that is soldered to the connector mounting surface 2A of the receptacle-side board 2, an embedded portion 7Q embedded in the receptacle-side male contact beam 27, and a protruding portion 7R that protrudes in the horizontal removal direction from the embedded portion 7Q. As shown in FIG. 3, the protruding portions 7R of the receptacle-side male contacts 7 are exposed externally without being covered by the receptacle-side male contact beam 27.

The two receptacle-side auxiliary fittings 9 are retained in the two receptacle-side connecting beams 29 by insert molding. Since the two receptacle-side auxiliary fittings 9 are symmetrical with respect to a bisecting plane that divides the receptacle connector 3 in the pitch direction, only one receptacle-side auxiliary fitting 9 is described below, and the description of the other is omitted.

As shown in FIG. 4, the receptacle-side auxiliary fitting 9 includes a base plate 9P that is soldered to the connector mounting surface 2A of the receptacle-side board 2, a top plate 9Q that covers the upper surface of the receptacle-side connecting beam 29, and four connecting portions 9R that connect the base plate 9P and the top plate 9Q.

The base plate 9P is positioned inward in the width direction relative to the top plate 9Q, and is also positioned below the top plate 9Q. The four connecting portions 9R are spaced generally equally in the width direction. The four connecting portions 9R protrude upward from the base plate 9P and extend to the top plate 9Q. The four connecting portions 9R include a first connecting portion 9RA, a second connecting portion 9RB, a third connecting portion 9RC, and a fourth connecting portion 9RD, arranged in this order in the horizontal mating direction.

The first connecting portion 9RA and the third connecting portion 9RC are each formed with a protrusion 9S that protrudes inward in the pitch direction. The protrusions 9S are typically formed by drawing.

The receptacle-side auxiliary fitting 9 further includes two receptacle-side interference portions 9T that protrude inward in the pitch direction from the top plate 9Q. The two receptacle-side interference portions 9T include a receptacle-side interference portion 9TA positioned between the first connecting portion 9RA and the second connecting portion 9RB, and a receptacle-side interference portion 9TB positioned between the third connecting portion 9RC and the fourth connecting portion 9RD. The two receptacle-side interference portions 9T are typically formed by lancing.

The receptacle-side auxiliary fitting 9 further includes an elastically deformable contact spring piece 9U that protrudes upward from the base plate 9P. The contact spring piece 9U is positioned between the second connecting portion 9RB and the third connecting portion 9RC. The contact spring piece 9U is formed, for example, by lancing.

### (Plug Connector 5)

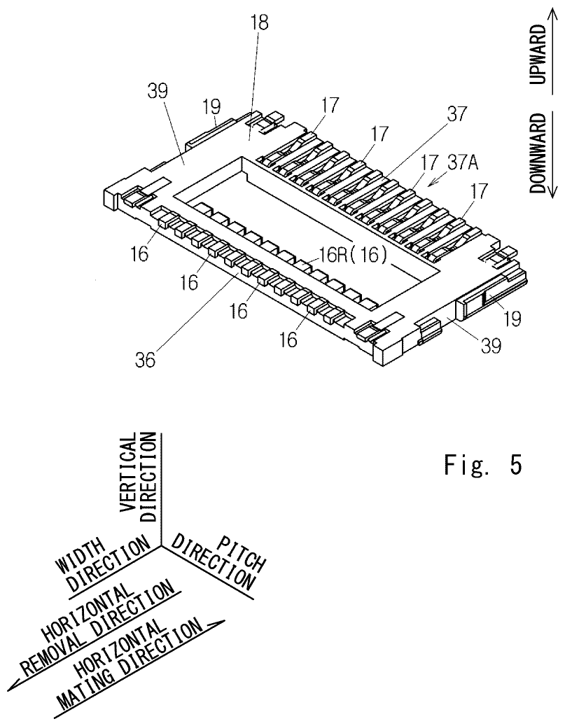

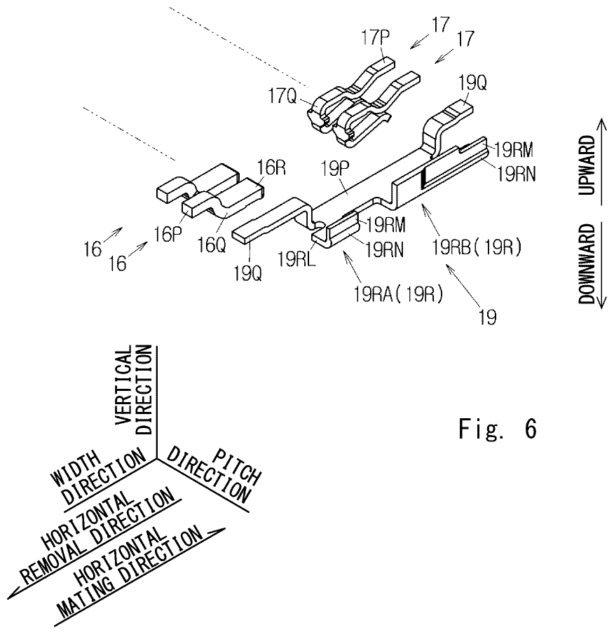

Next, the plug connector 5 will be described in more detail with reference to FIGS. 5 and 6. FIG. 5 is a perspective view of the plug connector 5. FIG. 6 is a perspective view showing only a part of the configuration of the plug connector 5.

The plurality of plug-side male contacts 16 are retained in the plug-side male contact beam 36 by insert molding. As shown in FIG. 6, each plug-side male contact 16 includes a soldering portion 16P that is soldered to the connector mounting surface 4A of the plug-side board 4, an embedded portion 16Q embedded in the plug-side male contact beam 36, and a protruding portion 16R that protrudes in the horizontal mating direction from the embedded portion 16Q. As shown in FIG. 5, the protruding portions 16R of the plug-side male contacts 16 are exposed externally without being covered by the plug-side male contact beam 36.

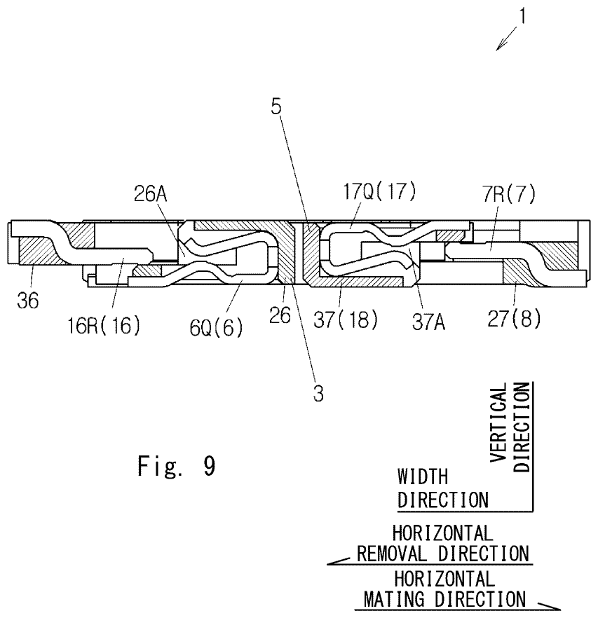

The plurality of plug-side female contacts 17 are press-fitted and retained in respective slits formed in the plug-side female contact beam 37. As shown in FIG. 6, each plug-side female contact 17 includes a soldering portion 17P that is soldered to the connector mounting surface 4A of the plug-side board 4, and a U-shaped contact portion 17Q that opens in the horizontal mating direction. As shown in FIG. 5, the plug-side female contact beam 37 is formed with an insertion opening 37A that opens in the horizontal mating direction. Note that the insertion opening 37A is clearly illustrated in FIG. 9 described later.

The two plug-side auxiliary fittings 19 are retained in the two plug-side connecting beams 39 by insert molding. Since the two plug-side auxiliary fittings 19 are symmetrical with respect to a bisecting plane that divides the plug connector 5 in the pitch direction, only one plug-side auxiliary fitting 19 is described below, and the description of the other is omitted.

As shown in FIG. 6, the plug-side auxiliary fitting 19 includes a bottom plate 19P, two soldering portions 19Q that are soldered to the connector mounting surface 4A of the plug-side board 4, and two L-shaped portions 19R.

The two soldering portions 19Q are each formed in an L-shape when viewed along the pitch direction and protrude outward in the width direction from the bottom plate 19P.

The two L-shaped portions 19R are each formed in an L-shape in the width direction and protrude outward in the pitch direction from the bottom plate 19P. The two L-shaped portions 19R are spaced apart in the width direction. The two L-shaped portions 19R include a first L-shaped portion 19RA and a second L-shaped portion 19RB, arranged in this order in the horizontal mating direction.

Each L-shaped portion 19R includes a plug-side interference portion 19RL that protrudes outward in the pitch direction from the bottom plate 19P, and a vertical portion 19RM that protrudes upward from the plug-side interference portion 19RL. A protruding portion 19RN that extends in the width direction and protrudes outward in the pitch direction is formed at the lower end of the vertical portion 19RM.

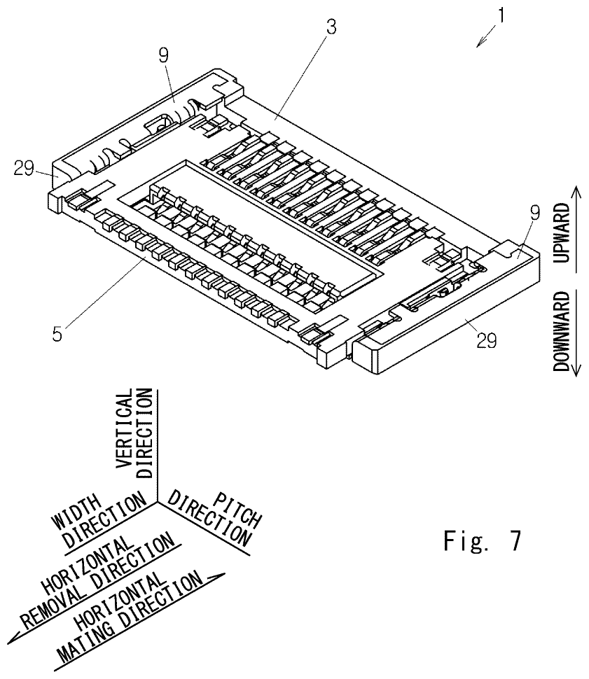

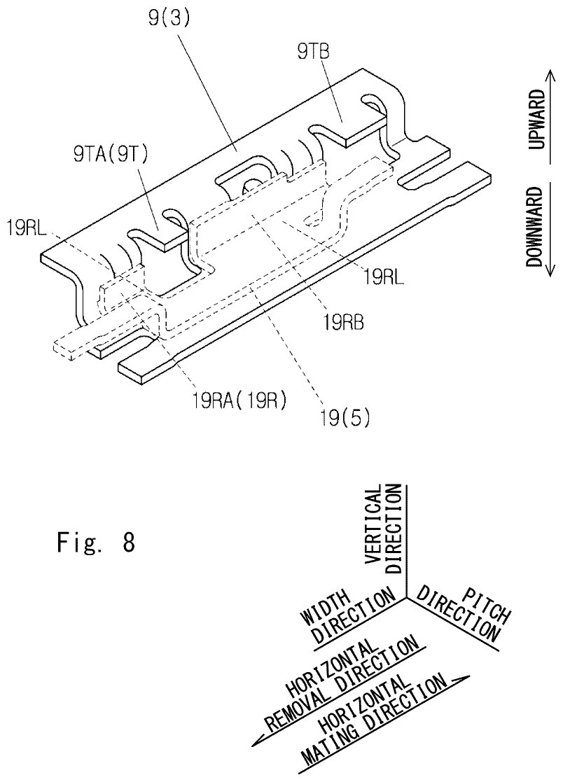

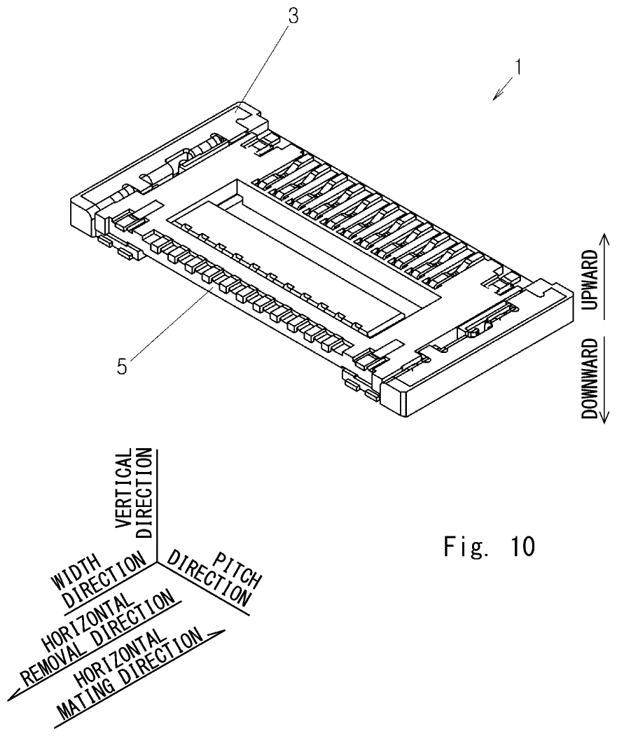

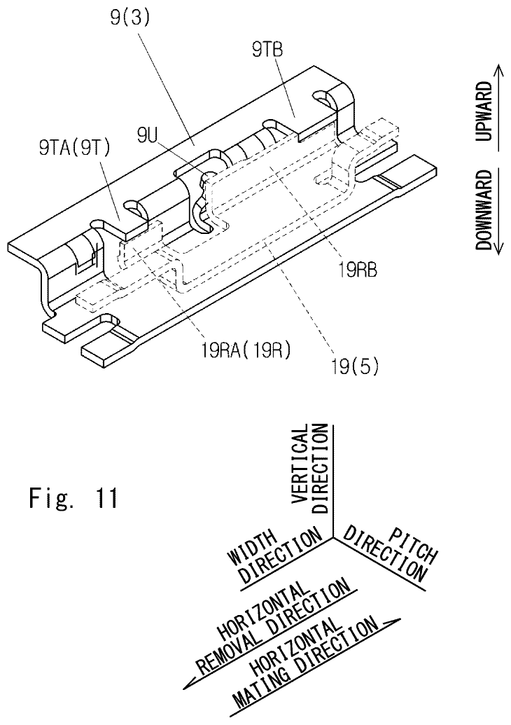

Next, with reference to FIGS. 7 through 11, the mating method of the connector assembly 1 will be described. FIG. 7 is a perspective view showing a state in which vertical insertion is completed. FIG. 8 is a perspective view showing the positional relationship between the receptacle-side auxiliary fitting 9 and the plug-side auxiliary fitting 19 after vertical insertion. FIG. 9 is a cross-sectional view showing a state in which vertical insertion is completed. FIG. 10 is a perspective view showing a state in which horizontal movement is completed. FIG. 11 is a perspective view showing the positional relationship between the receptacle-side auxiliary fitting 9 and the plug-side auxiliary fitting 19 after horizontal movement.

First, as shown in FIG. 1, the plug connector 5 is lowered toward the receptacle connector 3 in a state where the plug connector 5 and the receptacle connector 3 face each other in the vertical direction. As shown in FIG. 7, the plug connector 5 is vertically inserted into the receptacle connector 3 such that the plug connector 5 positions between the two receptacle-side connecting beams 29—that is, between the two receptacle-side auxiliary fittings 9.

More specifically, as shown in FIG. 8, the plug connector 5 is vertically inserted into the receptacle connector 3 such that, in the width direction, the second L-shaped portion 19RB of each plug-side auxiliary fitting 19 is positioned between the two receptacle-side interference portions 9T of each receptacle-side auxiliary fitting 9, and such that the receptacle-side interference portion 9TA of each receptacle-side auxiliary fitting 9 is positioned between the two L-shaped portions 19R of each plug-side auxiliary fitting 19.

During this vertical insertion, the two protruding portions 19RN of the L-shaped portions 19R of the plug-side auxiliary fitting 19 shown in FIG. 6 go over the two protrusions 9S of the receptacle-side auxiliary fitting 9. To achieve this, the plug-side board 4 must be pressed downward toward the receptacle-side board 2 with a relatively strong force. While going over, the user can feel a sudden release of pressing force through their fingers-providing a tactile feedback. By feeling this tactile feedback, the user can confirm successful vertical insertion through the tactile feedback in the fingertips.

After going over as described above, the plug connector 5 becomes seated on the receptacle connector 3, thereby achieving vertical positioning of the plug connector 5 relative to the receptacle connector 3. As a result of the vertical positioning, vertical insertion of the connector assembly 1 is completed.

FIG. 9 shows a cross-sectional view of the connector assembly 1 in a state where vertical insertion is completed. As shown in FIG. 9, in the state where the vertical insertion is completed, the protruding portions 16R of the plurality of plug-side male contacts 16 of the plug connector 5 face the insertion openings 26A of the receptacle-side female contact beams 26 of the receptacle connector 3 in the width direction. Similarly, in the state where the vertical insertion is completed, the protruding portions 7R of the plurality of receptacle-side male contacts 7 of the receptacle connector 3 face the insertion openings 37A of the plug-side female contact beams 37 of the plug connector 5 in the width direction.

In the state shown in FIG. 9, the plug connector 5 is horizontally moved in the width direction toward the receptacle connector 3. That is, the plug connector 5 is moved in the horizontal mating direction relative to the receptacle connector 3. As a result, the plug connector 5 becomes mated with the receptacle connector 3. Hereinafter, the state in which vertical insertion and horizontal movement are completed will be referred to as the mated state of the connector assembly 1, as shown in FIG. 10.

In the mated state of the connector assembly 1, as explained with reference to FIG. 9, the protruding portions 16R of the plug-side male contacts 16 come into contact with the contact portions 6Q of the receptacle-side female contacts 6, while elastically deforming the contact portions 6Q. Similarly, the protruding portions 7R of the receptacle-side male contacts 7 come into contact with the contact portions 17Q of the plug-side female contacts 17, while elastically deforming the contact portions 17Q.

FIG. 11 is a perspective view showing the positional relationship between the receptacle-side auxiliary fittings 9 and the plug-side auxiliary fittings 19 in the mated state. For ease of illustration, in FIG. 11, the receptacle-side auxiliary fittings 9 are shown in solid lines, and the plug-side auxiliary fittings 19 are shown in dashed lines. As shown in FIG. 11, in the mated state of the connector assembly 1, the first L-shaped portion 19RA is positioned below the receptacle-side interference portion 9TA, and the second L-shaped portion 19RB is positioned below the receptacle-side interference portion 9TB. Also, the contact spring piece 9U, which was in contact with the second L-shaped portion 19RB with elastic deformation upon completion of vertical insertion, remains in contact with the second L-shaped portion 19RB with elastic restoring force during the horizontal movement. In other words, the contact spring piece 9U slides over the second L-shaped portion 19RB while maintaining contact, thereby providing a wiping effect between the contact spring piece 9U and the second L-shaped portion 19RB, which ensures stable electrical connection between the receptacle-side auxiliary fittings 9 and the plug-side auxiliary fittings 19.

Returning to FIG. 8, suppose that the plug connector 5 is misaligned relative to the receptacle connector 3 in the horizontal mating direction during vertical insertion. In this case, the plug-side interference portion 19RL of the second L-shaped portion 19RB of each plug-side auxiliary fitting 19 physically interferes with the receptacle-side interference portion 9TB of each receptacle-side auxiliary fitting 9, and the plug-side interference portion 19RL of the first L-shaped portion 19RA physically interferes with the receptacle-side interference portion 9TA. As a result, insertion of the plug connector 5 into the receptacle connector 3 is effectively prevented. Moreover, when such insertion is prevented, the plug connector 5 is supported by the receptacle connector 3 in a horizontally level posture without tilting, due to contact at three or more points—in this embodiment, four contact points. Specifically, these four points include the four receptacle-side interference portions 9T on the receptacle connector 3 and the four plug-side interference portions 19RL on the plug connector 5. Accordingly, even if the plug connector 5 tilts relative to the receptacle connector 3 due to misalignment during vertical insertion, it is possible to prevent the plug-side female contact beam 37 from colliding downward with the protruding portions 7R of the receptacle-side male contacts 7 and damaging them, or the protruding portions 16R of the plug-side male contacts 16 from colliding downward with the receptacle-side female contact beam 26 and damaging them. In short, the connector assembly 1 of the present embodiment can prevent damage to the contacts even if a misalignment occurs in the width direction between the receptacle connector 3 and the plug connector 5 during vertical insertion.

Furthermore, since the above-described physical interference at the four points occurs between the receptacle-side auxiliary fittings 9 of the receptacle connector 3 and the plug connector 5, damage to the receptacle-side housing 8 of the receptacle connector 3 can be effectively prevented.

Furthermore, since the physical interference at the four points occurs between the receptacle-side auxiliary fittings 9 of the receptacle connector 3 and the plug-side auxiliary fittings 19 of the plug connector 5, damage can be effectively prevented not only to the receptacle-side housing 8 but also to the plug-side housing 18 of the plug connector 5.

As described above, the first embodiment of the present disclosure has been explained. The first embodiment includes the following features.

That is, the connector assembly 1 includes the receptacle connector 3 and the plug connector 5. The plug connector 5 is vertically inserted into the receptacle connector 3, and then horizontally moved relative to the receptacle connector 3, whereby the receptacle connector 3 and the plug connector 5 are electrically connected. The receptacle connector 3 includes the plurality of receptacle-side female contacts 6 (first receptacle-side contacts), the plurality of receptacle-side male contacts 7 (second receptacle-side contacts), the receptacle-side housing 8 that retains the plurality of receptacle-side female contacts 6 and the plurality of receptacle-side male contacts 7, and the two receptacle-side auxiliary fittings 9. The receptacle-side housing 8 includes the receptacle-side female contact beam 26 (first receptacle-side contact beam) that retains the plurality of receptacle-side female contacts 6, the receptacle-side male contact beam 27 (second receptacle-side contact beam) that retains the plurality of receptacle-side male contacts 7, and two receptacle-side connecting beams 29 that connect the receptacle-side female contact beam 26 and the receptacle-side male contact beam 27. The plug connector 5 includes the plurality of plug-side male contacts 16 (first plug-side contacts), the plurality of plug-side female contacts 17 (second plug-side contacts), the plug-side housing 18 that retains the plurality of plug-side male contacts 16 and the plurality of plug-side female contacts 17, and the two plug-side auxiliary fittings 19. The plug-side housing 18 includes the plug-side male contact beam 36 (first plug-side contact beam) that retains the plurality of plug-side male contacts 16, the plug-side female contact beam 37 (second plug-side contact beam) that retains the plurality of plug-side female contacts 17, and the two plug-side connecting beams 39 that connect the plug-side male contact beam 36 and the plug-side female contact beam 37. The connector assembly 1 is configured such that the plug connector 5 is vertically inserted into the receptacle connector 3 so as to be received between the two receptacle-side connecting beams 29, and then horizontally moved relative to the receptacle connector 3, whereby the plurality of receptacle-side female contacts 6 and the plurality of plug-side male contacts 16 come into contact with each other, and the plurality of receptacle-side male contacts 7 and the plurality of plug-side female contacts 17 come into contact with each other. The two receptacle-side auxiliary fittings 9 include at least three receptacle-side interference portions 9T that physically interfere with the plug connector 5 when a misalignment exists between the plug connector 5 and the receptacle connector 3 in the width direction (a facing direction in which the receptacle-side female contact beam 26 and the receptacle-side male contact beam 27 face each other) during vertical insertion. According to the above configuration, the connector assembly 1 effectively prevents damage to the contacts during mating. Additionally, damage to the receptacle-side housing 8 of the receptacle connector 3 can also be effectively prevented.

In the present embodiment, each of the two receptacle-side auxiliary fittings 9 includes two receptacle-side interference portions 9T, and thus the two receptacle-side auxiliary fittings 9 provide a total of four receptacle-side interference portions 9T. However, the invention is not limited to this configuration. The connector assembly 1 may include only one receptacle-side auxiliary fitting 9, which includes three receptacle-side interference portions 9T.

The receptacle connector 3 is not limited to having two receptacle-side auxiliary fittings 9. It may have only one or three or more. The plug connector 5 is also not limited to having two plug-side auxiliary fittings 19, and may have one or three or more.

Furthermore, the at least three receptacle-side interference portions 9T may be configured to physically interfere with the two plug-side auxiliary fittings 19 of the plug connector 5 when misalignment exists. With this configuration, damage to both the receptacle-side housing 8 and the plug-side housing 18 can be effectively prevented.

The at least three receptacle-side interference portions 9T may include four interference portions 9T. This configuration more reliably prevents the posture of the plug connector 5 from tilting, allowing it to be received in a level state by the receptacle connector 3.

Each receptacle-side auxiliary fitting 9 may include an elastically deformable contact spring piece 9U. When the plug connector 5 is vertically inserted into the receptacle connector 3, the contact spring piece 9U elastically deforms and comes into contact with the plug-side auxiliary fittings 19. While the plug connector 5 is horizontally moved relative to the receptacle connector 3, the contact spring piece 9U remains in contact with the plug-side auxiliary fittings 19 by elastic restoring force. With this configuration, a stable electrical connection is achieved between the receptacle-side and plug-side auxiliary fittings.

Each receptacle-side auxiliary fitting 9 may be formed with the protrusion 9S to provide tactile feedback during vertical insertion. With this configuration, the user can confirm successful vertical insertion by tactile sensation alone.

### Second Embodiment

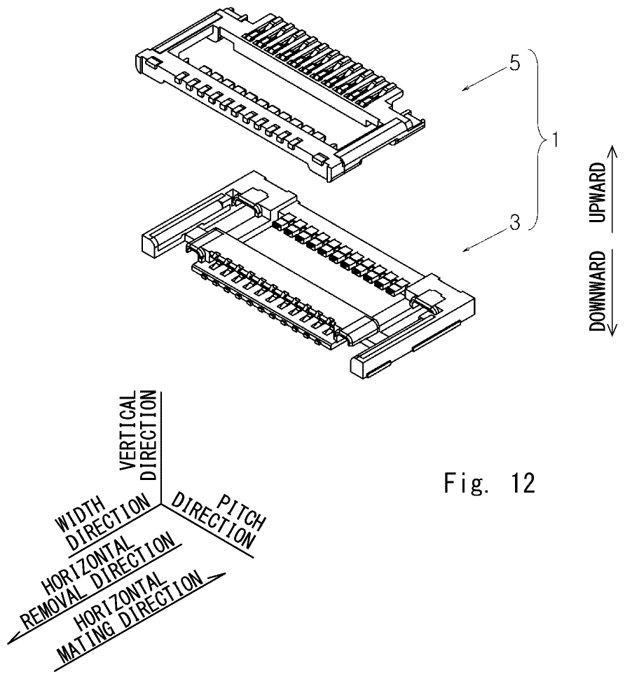

Next, with reference to FIGS. 12 through 17, a second embodiment of the present disclosure will be described. The following explanation focuses on the differences between the present embodiment and the first embodiment, and redundant descriptions are omitted.

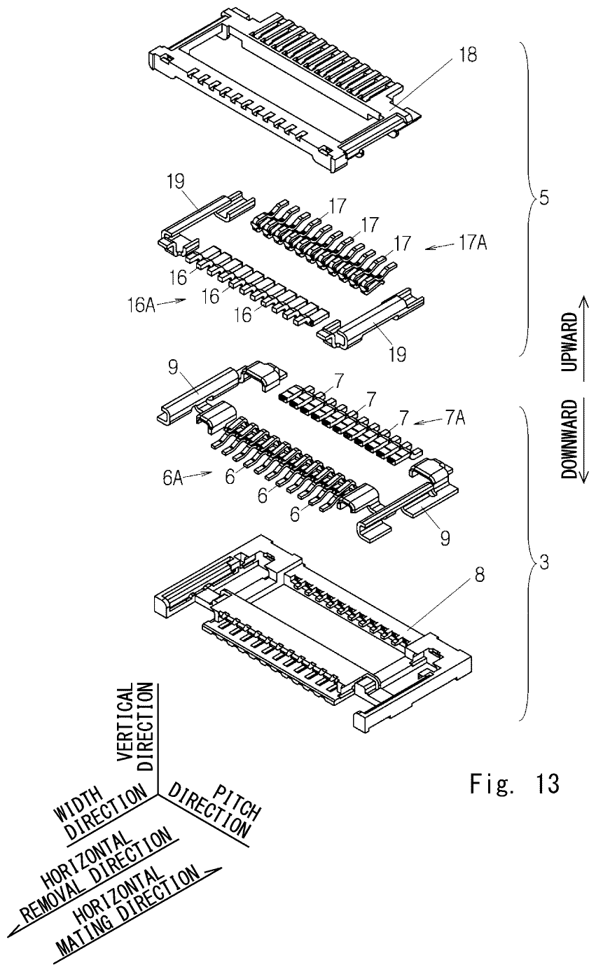

FIG. 12 is a perspective view showing the connector assembly 1 before mating. FIG. 13 is an exploded perspective view of the connector assembly 1. With reference to FIGS. 1, 2, 12, and 13, the primary differences between the present embodiment and the first embodiment lie in the shapes of the receptacle-side auxiliary fittings 9 and the plug-side auxiliary fittings 19. Therefore, the following description focuses on these components, and other descriptions are omitted.

### (Receptacle Connector 3)

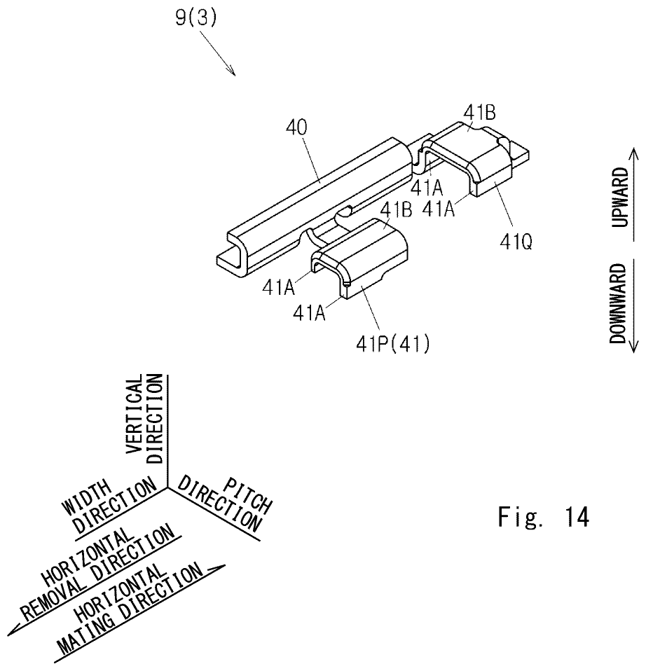

First, the receptacle-side auxiliary fitting 9 of the receptacle connector 3 will be described with reference to FIG. 14. FIG. 14 is a perspective view of the receptacle-side auxiliary fitting 9. As in the first embodiment, only one receptacle-side auxiliary fitting 9 will be described below, and the description of the other is omitted.

As shown in FIG. 14, the receptacle-side auxiliary fitting 9 includes a base plate 40 and two receptacle-side interference portions 41.

The base plate 40 is formed in a U-shape that opens outward in the pitch direction and extends in the width direction.

The two receptacle-side interference portions 41 are arranged to protrude inward in the width direction from the base plate 40. The two receptacle-side interference portions 41 are each formed in a U-shape that opens downward. The two receptacle-side interference portions 41 are spaced apart from each other in the width direction. Each receptacle-side interference portion 41 includes two receptacle-side U-shaped side walls 41A that face each other in the pitch direction, and a connecting portion 41B that connects the two receptacle-side U-shaped side walls 41A. The two receptacle-side interference portions 41 include a first receptacle-side interference portion 41P and a second receptacle-side interference portion 41Q. The first receptacle-side interference portion 41P and the second receptacle-side interference portion 41Q are arranged in this order in the horizontal mating direction.

### (Plug Connector 5)

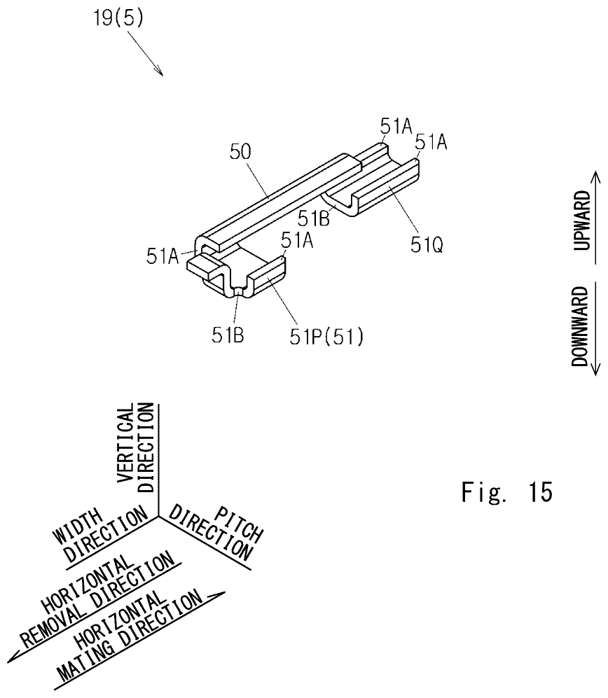

Next, the plug-side auxiliary fitting 19 of the plug connector 5 will be described with reference to FIG. 15. FIG. 15 is a perspective view of the plug-side auxiliary fitting 19. As in the first embodiment, only one plug-side auxiliary fitting 19 is described below, and the description of the other is omitted.

As shown in FIG. 15, the plug-side auxiliary fitting 19 includes a bottom plate 50 and two plug-side interference portions 51.

The base plate 50 is formed in a U-shape that opens inward in the pitch direction and extends in the width direction.

The two plug-side interference portions 51 are disposed to protrude inward in the width direction from the base plate 50. The two plug-side interference portions 51 are each formed in a U-shape that opens upward. The two plug-side interference portions 51 are spaced apart from each other in the width direction. Each plug-side interference portion 51 includes two plug-side U-shaped side walls 51A that face each other in the pitch direction, and a connecting portion 51B that connects the two plug-side U-shaped side walls 51A. The two plug-side interference portions 51 include a first plug-side interference portion 51P and a second plug-side interference portion 51Q. The first plug-side interference portion 51P and the second plug-side interference portion 51Q are arranged in this order in the horizontal mating direction.

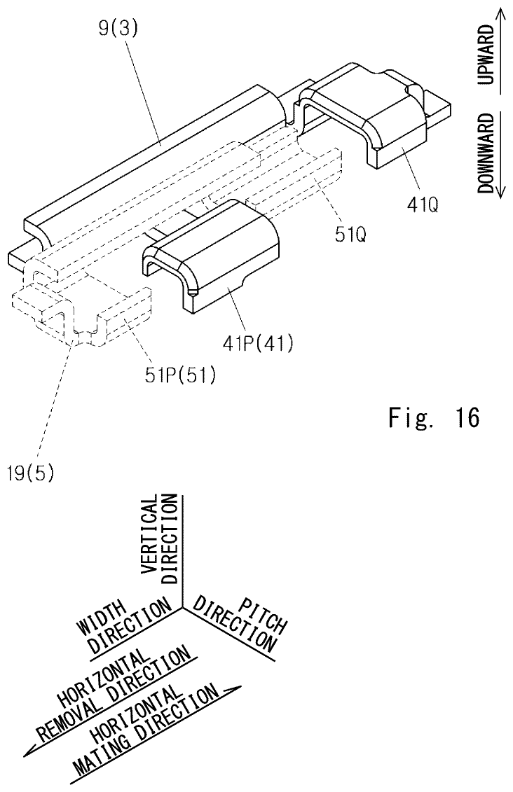

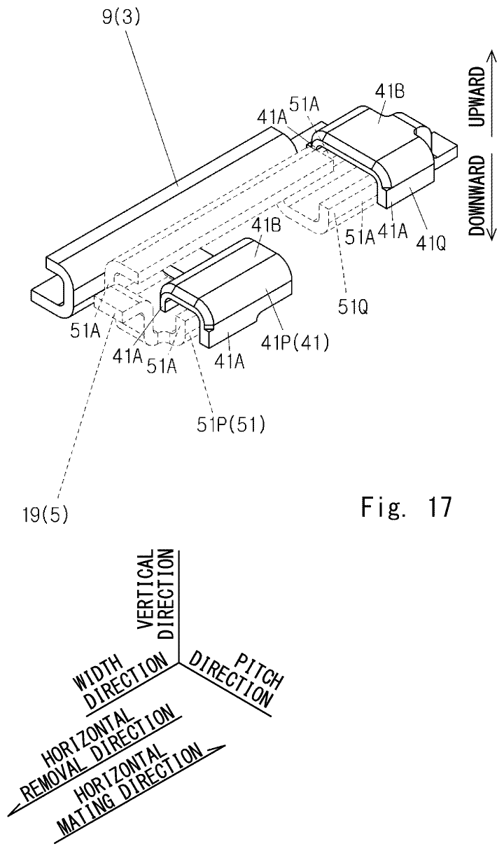

Next, with reference to FIGS. 16 and 17, a mating method of the connector assembly 1 will be described. FIG. 16 is a perspective view showing the positional relationship between the receptacle-side auxiliary fitting 9 and the plug-side auxiliary fitting 19 in a state where vertical insertion is completed. FIG. 17 is a perspective view showing the positional relationship between the receptacle-side auxiliary fitting 9 and the plug-side auxiliary fitting 19 in a state where horizontal movement is completed. In FIGS. 16 and 17, for illustrative clarity, the receptacle-side auxiliary fittings 9 are shown with solid lines, and the plug-side auxiliary fittings 19 are shown with dashed lines.

First, the plug connector 5 is vertically inserted into the receptacle connector 3. Specifically, as shown in FIG. 16, in the width direction, the first receptacle-side interference portion 41P of each receptacle-side auxiliary fitting 9 of the receptacle connector 3 is positioned between the two plug-side interference portions 51 of each plug-side auxiliary fitting 19 of the plug connector 5. Also, the second plug-side interference portion 51Q of each plug-side auxiliary fitting 19 of the plug connector 5 is positioned between the two receptacle-side interference portions 41 of each receptacle-side auxiliary fitting 9 of the receptacle connector 3. As a result of this vertical insertion, the plug connector 5 becomes seated in the receptacle connector 3, thereby achieving vertical positioning of the plug connector 5 relative to the receptacle connector 3. This vertical positioning completes the vertical insertion of the connector assembly 1.

Next, in the state shown in FIG. 16, the plug connector 5 is horizontally moved in the width direction toward the receptacle connector 3. That is, the plug connector 5 is moved relative to the receptacle connector 3 in the horizontal mating direction. As a result, the plug connector 5 is mated with the receptacle connector 3. Hereinafter, the state in which vertical insertion and horizontal movement are completed will be referred to as the mated state of the connector assembly 1, as shown in FIG. 17.

As shown in FIG. 17, in the mated state of the connector assembly 1, the first plug-side interference portion 51P of each plug-side auxiliary fitting 19 of the plug connector 5 is positioned below the first receptacle-side interference portion 41P of each receptacle-side auxiliary fitting 9 of the receptacle connector 3. Specifically, among the two plug-side U-shaped side walls 51A of the first plug-side interference portion 51P, the inward one in the pitch direction is positioned between the two receptacle-side U-shaped side walls 41A of the first receptacle-side interference portion 41P in the pitch direction. In other words, among the two receptacle-side U-shaped side walls 41A of the first receptacle-side interference portion 41P, the outward one in the pitch direction is positioned between the two plug-side U-shaped side walls 51A of the first plug-side interference portion 51P in the pitch direction. In short, in the mated state of the connector assembly 1, the two plug-side U-shaped side walls 51A of the first plug-side interference portion 51P and the two receptacle-side U-shaped side walls 41A of the first receptacle-side interference portion 41P are alternately overlapped in the pitch direction.

Continuing with reference to FIG. 17, in the mated state of the connector assembly 1, the second plug-side interference portion 51Q of each plug-side auxiliary fitting 19 of the plug connector 5 is positioned below the second receptacle-side interference portion 41Q of each receptacle-side auxiliary fitting 9 of the receptacle connector 3. Specifically, in the mated state of the connector assembly 1, the two plug-side U-shaped side walls 51A of the second plug-side interference portion 51Q are positioned between the two receptacle-side U-shaped side walls 41A of the second receptacle-side interference portion 41Q in the pitch direction. In other words, in the mated state of the connector assembly 1, the two receptacle-side U-shaped side walls 41A of the second receptacle-side interference portion 41Q are positioned outside the two plug-side U-shaped side walls 51A of the second plug-side interference portion 51Q in the pitch direction.

Here, similarly to the first embodiment, suppose that the plug connector 5 is misaligned relative to the receptacle connector 3 in the horizontal mating direction during vertical insertion. In this case, as shown in FIG. 16, the second plug-side interference portion 51Q of each plug-side auxiliary fitting 19 of the plug connector 5 physically interferes with the second receptacle-side interference portion 41Q of each receptacle-side auxiliary fitting 9 of the receptacle connector 3, and the first plug-side interference portion 51P physically interferes with the first receptacle-side interference portion 41P. As a result, vertical insertion of the plug connector 5 into the receptacle connector 3 is effectively inhibited. Moreover, when such vertical insertion is prevented, the plug connector 5 is supported by the receptacle connector 3 in a horizontally level posture without tilting, due to contact at three or more points—in this embodiment, four contact points. Accordingly, as in the first embodiment, even when misalignment occurs during vertical insertion, damage to the contacts can be effectively prevented.

The second embodiment of the present disclosure has been described above. The second embodiment includes the following features.

Each plug-side auxiliary fitting 19 includes two plug-side interference portions 51 corresponding respectively to the two receptacle-side interference portions 41. Each of the two receptacle-side interference portions 41 is formed in a U-shape that opens downward and includes two receptacle-side U-shaped side walls 41A. Each of the two plug-side interference portions 51 is formed in a U-shape that opens upward and includes two plug-side U-shaped side walls 51A. According to this configuration, the receptacle-side interference portions 41 and the plug-side interference portions 51 have a large second moment of area in cross-section and are resistant to buckling.

As shown in FIG. 17, when the plug connector 5 is horizontally moved relative to the receptacle connector 3, the two receptacle-side U-shaped side walls 41A of the first receptacle-side interference portion 41P and the two plug-side U-shaped side walls 51A of the first plug-side interference portion 51P are alternately overlapped. According to this configuration, the first receptacle-side interference portion 41P and the first plug-side interference portion 51P can function as guides during horizontal movement.

As shown in FIG. 17, when the plug connector 5 is horizontally moved relative to the receptacle connector 3, the two plug-side U-shaped side walls 51A of the second plug-side interference portion 51Q are inserted between the two receptacle-side U-shaped side walls 41A of the second receptacle-side interference portion 41Q. According to this configuration, the second receptacle-side interference portion 41Q and the second plug-side interference portion 51Q can function as guides during horizontal movement.

The invention made by the present inventors has been specifically described above based on embodiments. However, the present invention is not limited to the above-described embodiments, and it is needless to say that various modifications may be made without departing from the spirit and scope of the invention.

The first and second embodiments can be combined as desirable by one of ordinary skill in the art.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A connector assembly comprising:
a receptacle connector; and
a plug connector;
wherein the plug connector is vertically inserted into the receptacle connector and then horizontally moved relative to the receptacle connector, whereby the receptacle connector and the plug connector are electrically connected,
wherein the receptacle connector comprises:
a plurality of first receptacle-side contacts;
a plurality of second receptacle-side contacts;
a receptacle-side housing that retains the plurality of first receptacle-side contacts and the plurality of second receptacle-side contacts; and
at least one receptacle-side auxiliary fitting,
wherein the receptacle-side housing comprises:
a first receptacle-side contact beam that retains the plurality of first receptacle-side contacts;
a second receptacle-side contact beam that retains the plurality of second receptacle-side contacts; and
two receptacle-side connecting beams that connect the first and second receptacle-side contact beams,
wherein the plug connector comprises:
a plurality of first plug-side contacts;
a plurality of second plug-side contacts;
a plug-side housing that retains the plurality of first plug-side contacts and the plurality of second plug-side contacts; and
at least one plug-side auxiliary fitting,
wherein the plug-side housing comprises:
a first plug-side contact beam that retains the plurality of first plug-side contacts;
a second plug-side contact beam that retains the plurality of second plug-side contacts; and
two plug-side connecting beams that connect the first and second plug-side contact beams,
wherein the plug connector is vertically inserted into the receptacle connector such that the plug connector is accommodated between the two receptacle-side connecting beams, and is then horizontally moved relative to the receptacle connector such that the plurality of first receptacle-side contacts respectively contact the plurality of first plug-side contacts and the plurality of second receptacle-side contacts respectively contact the plurality of second plug-side contacts, and
wherein the at least one receptacle-side auxiliary fitting includes at least three receptacle-side interference portions that physically interfere with the plug connector when a misalignment exists between the plug connector and the receptacle connector in a facing direction in which the first and second receptacle-side contact beams face each other during the vertical insertion.

2. The connector assembly according to claim 1,
wherein the at least three receptacle-side interference portions are configured to physically interfere with the at least one plug-side auxiliary fitting of the plug connector when the misalignment exists.

3. The connector assembly according to claim 1,
wherein the at least three receptacle-side interference portions include four receptacle-side interference portions.

4. The connector assembly according to claim 1,
wherein the at least one receptacle-side auxiliary fitting includes an elastically deformable contact spring piece,
wherein, when the plug connector is vertically inserted into the receptacle connector, the contact spring piece elastically deforms and comes into contact with the at least one plug-side auxiliary fitting, and
wherein, while the plug connector is horizontally moved relative to the receptacle connector, the contact spring piece remains in contact with the at least one plug-side auxiliary fitting by elastic restoring force.

5. The connector assembly according to claim 1,
wherein the at least one receptacle-side auxiliary fitting includes a protrusion configured to provide tactile feedback during the vertical insertion.

6. The connector assembly according to claim 1,
wherein the at least one plug-side auxiliary fitting includes at least three plug-side interference portions corresponding respectively to the at least three receptacle-side interference portions,
wherein each of the at least three receptacle-side interference portions is formed in a U-shape that opens downward and includes two receptacle-side U-shaped side walls, and
wherein each of the at least three plug-side interference portions is formed in a U-shape that opens upward and includes two plug-side U-shaped side walls.

7. The connector assembly according to claim 6,
wherein, when the plug connector is horizontally moved relative to the receptacle connector, the two receptacle-side U-shaped side walls of at least one of the at least three receptacle-side interference portions and the two plug-side U-shaped side walls of at least one of the at least three plug-side interference portions are alternately overlapped.

8. The connector assembly according to claim 6,
wherein, when the plug connector is horizontally moved relative to the receptacle connector, the two plug-side U-shaped side walls of at least one of the at least three plug-side interference portions are inserted between the two receptacle-side U-shaped side walls of at least one of the at least three receptacle-side interference portions.
